(19) United States
(12) Patent Application Publication
(10) Pub. No.: US 2023/0132018 A1
(43) Pub. Date: Apr. 27, 2023

(54) Electronic Wristwatch with an Easily Adjustable Rotating Crown

(71) Applicants: Wenjin Wu, Dongguan City (CN); Jiatao Chen, Dongguan City (CN)

(72) Inventors: Wenjin Wu, Dongguan City (CN); Jiatao Chen, Dongguan City (CN)

(21) Appl. No.: 17/563,086

(22) Filed: Dec. 28, 2021

(30) Foreign Application Priority Data
Oct. 25, 2021 (CN) 20212265112.X

(51) Int. Cl. G04B 19/28; G04G 21/00

(52) U.S. Cl. CPC G04B 19/283; G04G 21/00

(57) ABSTRACT

The present application discloses an electronic wristwatch with an easily adjustable rotating crown, comprising a watch case, and one side of the watch case is provided with a bezel, the other side is provided with a bottom cover, and the watch case is provided with a movement, the external side of the watch case is provided with a circular operation hole, and an adjusting gear is provided in the circular operation hole, the adjusting gear comprises a circular disk, and the side edge of the circular disk, which is close to the movement, is provided with a tapered row of teeth 1 along the circumferential direction, the side of the circular disk, which is away from the movement, is provided with a connecting post, and the free end of the connecting post is provided with a threaded post, the connecting post is externally sleeved with a crown tube.

### BACKGROUND OF THE INVENTION

### Field of the Invention

The invention relates to a wristwatch technical field, in particular to an electronic wristwatch with an easily adjustable rotating crown.

### Description of the Related Art

The crown is a structure on the wristwatch to adjust and calibrate time and calendars, generally divided into common crowns and spiral crowns. The common crowns can be directly pulled out to perform adjustment and calibration, and generally spiral crowns can be pulled out to perform adjustment and calibration after counterclockwise rotation and then unlocking. However, the crown of the electronic wristwatch neither need be pulled out nor need unlocking by rotation, which can be directly rotated to perform adjustment and calibration. The movements of some electronic wristwatch are independently detachable and they can be directly fitted in the watch cases with watch chains, and users can change diverse watch cases and watch straps according to personal preference; but the following problems exist in the meantime, when time and calendars need to be adjusted and calibrated, the movements need to be detached from the watch cases, and frequent detachment and installation undoubtedly cause wear and scratch.

### SUMMARY OF THE INVENTION

The technical problem which the invention aims to solve is to solve the above problems, by providing an electronic wristwatch with an easily adjustable rotating crown, which can adjust and calibrate time and calendars without detachment.

To solve the above technical problem, the technical scheme provided by the invention is as follows: an electronic wristwatch with an easily adjustable rotating crown, comprising a watch case, and one side of the watch case is provided with a bezel, the other side is provided with a bottom cover, and the watch case is provided with a movement, the external side of the watch case is provided with a circular operation hole, and an adjusting gear is provided in the circular operation hole, the adjusting gear comprises a circular disk, and the side edge of the circular disk, which is close to the movement, is provided with a tapered row of teeth 1 along the circumferential direction, the side of the circular disk, which is away from the movement, is provided with a connecting post, and the free end of the connecting post is provided with a threaded post, the connecting post is externally sleeved with a crown tube, and the crown tube is movably connected with the connecting post, the crown tube comprises a fixing ring and a spacing ring that are fixedly connected with each other, and a spring is sleeved on the external side of the connecting post and located in the fixing ring, the spacing ring is located outside the circular operation hole, and the external diameter of the spring is larger than the internal diameter of the spacing ring, the spacing ring is externally sleeved with the rotating crown, and the rotating crown comprises an outer ring, one side of the outer ring is provided with a closing plate, and an inner ring is provided in the outer ring, the inner ring and the closing plate are fixedly connected with each other, and internal threads are provided in the inner ring and connected with threads of the threaded post.

Further, the external diameter of the spacing ring is larger than the diameter of the circular operation hole.

Further, the external side of the watch case is provided with a watch strap.

Further, the external side of the outer ring is provided with antiskid threads.

The advantage of the invention compared with the current technology is as follows: the rotating crown of the invention can directly drive the self-contained crown on the movement, so as to achieve the purpose of adjusting and calibrating time and calendars without detachment of the movement.

### BRIEF DESCRIPTION OF THE DRAWINGS

FIG. 1 is a front structural schematic view of an electronic wristwatch with an easily adjustable rotating crown in the invention.

FIG. 2 is a structural schematic view of the rotating crown of an electronic wristwatch with an easily adjustable rotating crown in the invention.

FIG. 3 is a structural schematic view of the adjusting gear of an electronic wristwatch with an easily adjustable rotating crown in the invention.

FIG. 4 is a structural schematic view of the crown tube of an electronic wristwatch with an easily adjustable rotating crown in the invention.

As shown in the figures, 1. the outer ring; 2. the closing plate; 3. the inner ring; 4. the internal threads; 5. the antiskid threads; 6. the watch case; 7. the bezel; 8. the bottom cover; 9. the movement; 10. the circular operation hole; 11. the adjusting gear; 12. the circular disk; 13. the tapered row of teeth 1; 14. the connecting post; 15. the threaded post; 16. the crown tube; 17. the fixing ring; 18. the spacing ring; 19. the spring; 20. the watch strap.

### DESCRIPTION OF EMBODIMENTS

A further detailed description of the invention is given below in combination with the attached drawings.

### Embodiment 1

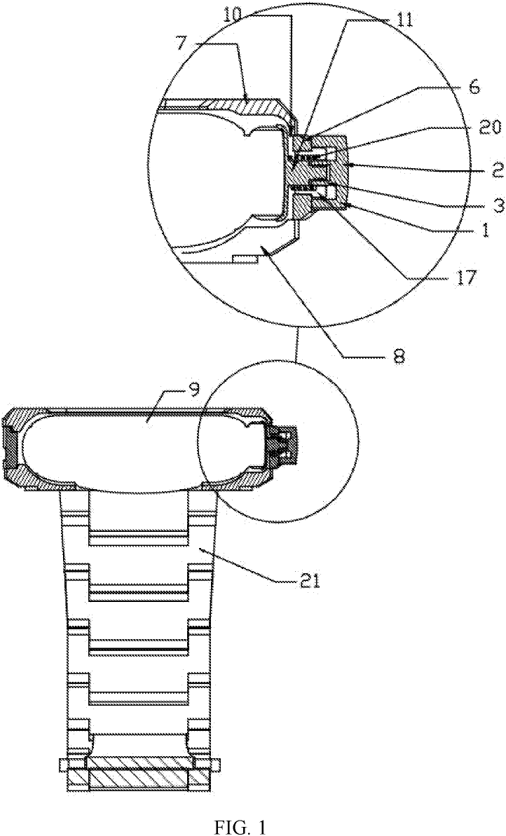

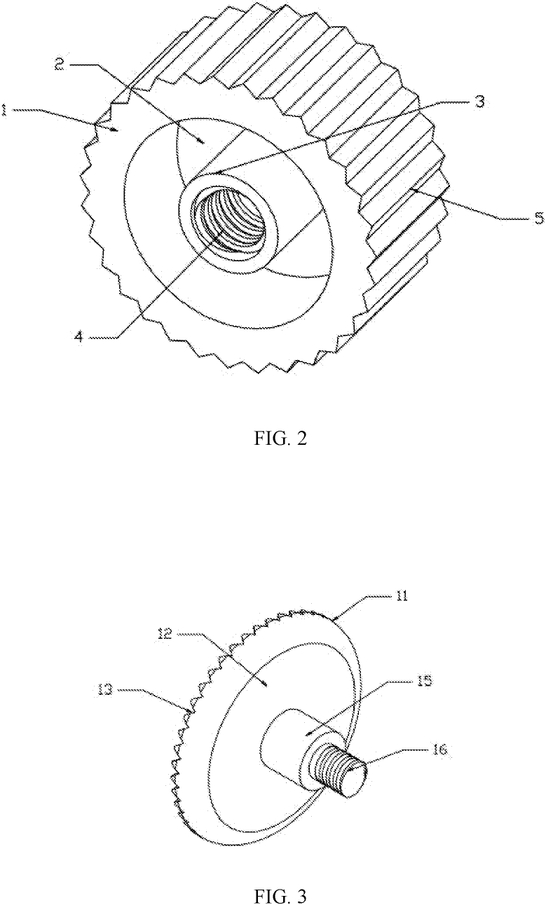

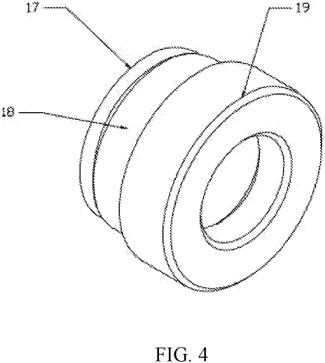

In combination with the attached drawings of FIG. 1, FIG. 2, FIG. 3 and FIG. 4, an electronic wristwatch with an easily adjustable rotating crown, comprising a watch case 6, and one side of the watch case 6 is provided with a bezel 7, the other side is provided with a bottom cover 8, and the watch case 6 is provided with a movement 9, the external side of the watch case 6 is provided with a circular operation hole 10, and an adjusting gear 11 is provided in the circular operation hole 10, the adjusting gear 11 comprises a circular disk 12, and the side edge of the circular disk 12, which is close to the movement 9, is provided with a tapered row of teeth 1 13 along the circumferential direction, the side of the circular disk 12, which is away from the movement 9, is provided with a connecting post 15, and the free end of the connecting post 15 is provided with a threaded post 16, the connecting post 15 is externally sleeved with a crown tube 17, and the crown tube 17 is movably connected with the connecting post 15, the crown tube 17 comprises a fixing ring 18 and a spacing ring 19 that are fixedly connected with each other, and a spring 20 is sleeved on the external side of the connecting post 15 and located in the fixing ring 18, the spacing ring 19 is located outside the circular operation hole 10, and the external diameter of the spring 20 is larger than the internal diameter of the spacing ring 19, the spacing ring 19 is externally sleeved with the rotating crown, and the rotating crown comprises an outer ring 1, one side of the outer ring 1 is provided with a closing plate 2, and an inner ring 3 is provided in the outer ring 1, the inner ring 3 and the closing plate 2 are fixedly connected with each other, and internal threads 4 are provided in the inner ring 3 and connected with threads of the threaded post 16, the external side of the outer ring 1 is provided with antiskid threads 5.

When specifically implementing the invention, the adjusting gear is placed into the interior of the watch case and is corresponding to the position of the circular operation hole on the side of the watch case, and a screw post is outward; the spring is placed outside the connecting post and then the crown tube is placed, and the external diameter of the spacing ring of the crown tube is larger than the diameter of the operation hole, the spacing ring can’t be inserted when it touches the watch case, and meanwhile, the fixing ring of the crown tube exactly matches the operation hole and they are fixed with each other; in the meantime, the spring is sleeved on the connecting post of the adjusting gear and located inside the crown tube, one end of the spring is put against the circular disk, and the other end is put against the interior of the spacing ring of the crown tube (the internal diameter of the spacing ring of the crown tube is smaller than the diameter of the spring), at this moment the spring is in the natural state, and the adjusting gear is in the freely movable state; the rotating crown is inserted in the hollow place of the crown tube from the surface of the watch case, and the gear is fixed, in the meantime the internal threads of the inner ring of the rotating crown are screwed into the threaded post of the adjusting gear, and at this moment the outer ring of the rotating crown is put against the watch case, the spring is in the compressed state; then the rotating crown is pulled outward, the spring is compressed by the pressure between the circular disk and the watch case, and the gear moves towards the inner surface of the watch case to spare enough space to put in the movement; the rotating crown is loosened after the movement is put in, and under the function of elastic force, the adjusting gear touches the crown of the movement, and the rotating crown is rotated so that the tapered row of teeth 1 on the circular disk and the tapered row of teeth 2 on the crown of the movement are embedded and stuck with each other; at this moment the rotating crown is rotated again to drive the crown of the movement inside the watch case to realize adjustment and calibration.

### Embodiment 2

In combination with the attached drawings of FIG. 1, FIG. 2, FIG. 3 and FIG. 4, an electronic wristwatch with an easily adjustable rotating crown, comprising a watch case 6, and one side of the watch case 6 is provided with a bezel 7, the other side is provided with a bottom cover 8, and the watch case 6 is provided with a movement 9, the external side of the watch case 6 is provided with a circular operation hole 10, and an adjusting gear 11 is provided in the circular operation hole 10, the adjusting gear 11 comprises a circular disk 12, and the side edge of the circular disk 12, which is close to the movement 9, is provided with a tapered row of teeth 1 13 along the circumferential direction, the side of the circular disk 12, which is away from the movement 9, is provided with a connecting post 15, and the free end of the connecting post 15 is provided with a threaded post 16, the connecting post 15 is externally sleeved with a crown tube 17, and the crown tube 17 is movably connected with the connecting post 15, the crown tube 17 comprises a fixing ring 18 and a spacing ring 19 that are fixedly connected with each other, and a spring 20 is sleeved on the external side of the connecting post 15 and located in the fixing ring 18, the spacing ring 19 is located outside the circular operation hole 10, and the external diameter of the spring 20 is larger than the internal diameter of the spacing ring 19, the spacing ring 19 is externally sleeved with the rotating crown, and the rotating crown comprises an outer ring 1, one side of the outer ring 1 is provided with a closing plate 2, and an inner ring 3 is provided in the outer ring 1, the inner ring 3 and the closing plate 2 are fixedly connected with each other, and internal threads 4 are provided in the inner ring 3 and connected with threads of the threaded post 16, the external diameter of the spacing ring 19 is larger than the diameter of the circular operation hole 10, and the external side of the watch case 6 is provided with a watch strap 21.

When specifically implementing the invention, the adjusting gear is placed into the interior of the watch case and is corresponding to the position of the circular operation hole on the side of the watch case, and a screw post is outward; the spring is placed outside the connecting post and then the crown tube is placed, and the external diameter of the spacing ring of the crown tube is larger than the diameter of the operation hole, the spacing ring can’t be inserted when it touches the watch case, and meanwhile, the fixing ring of the crown tube exactly matches the operation hole and they are fixed with each other; in the meantime, the spring is exactly sleeved on the connecting post of the adjusting gear and located inside the crown tube, one end of the spring is put against the circular disk, and the other end is put against the interior of the spacing ring of the crown tube (the internal diameter of the spacing ring of the crown tube is smaller than the diameter of the spring), at this moment the spring is in the natural state, and the adjusting gear is in the freely movable state; the rotating crown is inserted in the hollow place of the crown tube from the surface of the watch case, and the gear is fixed, in the meantime the internal threads of the inner ring of the rotating crown are screwed into the threaded post of the adjusting gear, and at this moment the outer ring of the rotating crown is put against the watch case, the spring is in the compressed state; then the rotating crown is pulled outward, the spring is compressed by the pressure between the circular disk and the watch case, and the gear moves towards the inner surface of the watch case to spare enough space to put in the movement; the rotating crown is loosened after the movement is put in, and under the function of elastic force, the adjusting gear touches the crown of the movement, and the rotating crown is rotated so that the tapered row of teeth 1 on the circular disk and the tapered row of teeth 2 on the crown of the movement are embedded and stuck with each other; at this moment the rotating crown is rotated again to drive the crown of the movement inside the watch case to realize adjustment and calibration.

The principle of the invention, one side of the watch case is provided with a circular operation hole, used to place the fixed crown tube; the movement comprises the self-contained crown, and the external surface of the crown is the tapered row of teeth 2, the self-contained crown neither need be pulled out nor need unlocking by rotation, and the rotating crown can be directly rotated to perform adjustment and calibration of the wristwatch; the adjusting gear is comprised of a circular disk, a connecting post and a threaded post, and the circular disk is provided with the tapered row of teeth 1; the rotating crown is comprised of an outer ring and an inner ring, and the inner surface of the inner ring is provided with inner threads; the crown tube is comprised of a spacing ring and a fixing ring.

The invention and the embodiments thereof are described hereinabove, and this description is not restrictive, what is shown in the drawings is only one of the embodiments of the invention, and the actual structure is not limited thereto. In summary, without departing from the inventive purpose of the invention, structural methods and embodiments similar to the technical scheme without creative efforts, made by common technicians in the field who are inspired, shall all fall within the protection scope of the invention.

1. An electronic wristwatch with an easily adjustable rotating crown, comprising a watch case (6), and one side of the watch case (6) is provided with a bezel (7), the other side is provided with a bottom cover (8), and the watch case (6) is provided with a movement (9), the external side of the watch case (6) is provided with a circular operation hole (10), and an adjusting gear (11) is provided in the circular operation hole (10), the adjusting gear (11) comprises a circular disk (12), and the side edge of the circular disk (12), which is close to the movement (9), is provided with a tapered row of teeth 1 (13) along the circumferential direction, the side of the circular disk (12), which is away from the movement (9), is provided with a connecting post (15), and the free end of the connecting post (15) is provided with a threaded post (16), the connecting post (15) is externally sleeved with a crown tube (17), and the crown tube (17) is movably connected with the connecting post (15), the crown tube (17) comprises a fixing ring (18) and a spacing ring (19) that are fixedly connected with each other, and a spring (20) is sleeved on the external side of the connecting post (15) and located in the fixing ring (18), the spacing ring (19) is located outside the circular operation hole (10), and the external diameter of the spring (20) is larger than the internal diameter of the spacing ring (19), the spacing ring (19) is externally sleeved with the rotating crown, and the rotating crown comprises an outer ring (1), one side of the outer ring (1) is provided with a closing plate (2), and an inner ring (3) is provided in the outer ring (1), the inner ring (3) and the closing plate (2) are fixedly connected with each other, and internal threads (4) are provided in the inner ring (3) and connected with threads of the threaded post (16).

2. The electronic wristwatch with an easily adjustable rotating crown according to claim 1, wherein the external diameter of the spacing ring (19) is larger than the diameter of the circular operation hole (10).

3. The electronic wristwatch with an easily adjustable rotating crown according to claim 1, wherein the external side of the watch case (6) is provided with a watch strap(21).

4. The electronic wristwatch with an easily adjustable rotating crown according to claim 1, wherein the external side of the outer ring (1) is provided with antiskid threads(5).
